(19) United States
(12) Patent Application Publication
(10) Pub. No.: US 2018/0147581 A1
(43) Pub. Date: May 31, 2018

(54) SEPARATOR

(71) Applicant: GEA MECHANICAL EQUIPMENT GMBH, Oelde (DE)

(72) Inventors: Kathrin QUITER, Drensteinfurt (DE); Wilfried MACKEL, Lippetal-Herzfeld (DE); Thomas BATHELT, Oelde (DE); Frank TAETZ, Delbrück (DE)

(73) Assignee: GEA MECHANICAL EQUIPMENT GMBH, Oelde (DE)

(21) Appl. No.: 15/574,523

(22) PCT Filed: May 6, 2016
(86) PCT No.: PCT/EP2016/060174

§ 371 Date: Nov. 16, 2017

(30) Foreign Application Priority Data
Jun. 2, 2015 (DE) 10 2015 108 741.3

(51) Int. Cl. B04B 9/12; B04B 1/08; B04B 7/14; B04B 9/04

(52) U.S. Cl. CPC B04B 9/12; B04B 9/04; B04B 7/14; B04B 1/08

(57) ABSTRACT

A separator for centrifugally processing a flowable product includes a rotating system with at least one rotatable drum delimiting a centrifugal chamber and at least one drive spindle for rotating or driving the drum. At least one non-rotating housing surrounds the drum. A mounting device for mounting the drive spindle in a mounting receiving housing is arranged or formed on the housing. A support arrangement is configured between the outer circumference of the bearing device and the inner circumference of the bearing receiving housing. The support arrangement is designed to provide on the whole an elastic radial support of the bearing device on the bearing receiving housing, and thus on the housing.

### BACKGROUND AND SUMMARY OF THE INVENTION

Exemplary embodiment of the invention relate to a separator for the centrifugal processing of a flowable product, having at least the following features: a rotating system with at least one rotatable drum delimiting a centrifugal chamber and at least one drive spindle for driving the drum, a non-rotatable housing at least surrounding the drum and a bearing device for mounting the drive spindle.

Centrifugal separators for achieving continuous operation have been known for some time, for example in an embodiment as nozzle separators as disclosed in Japanese patent document JP 62-40649 A. Apart from nozzle separators, separators with solid discharge openings are known in the art, to which a hydraulically actuable piston slide valve is assigned, by means of which the solid discharge openings can be closed and opened. A separator without a solid discharge in the form of a separator is shown in U.S. Pat. No. 2,017,734. A separator with solid drum lower and upper sections screwed to one another is furthermore shown in U.S. Pat. No. 2,286,354.

In addition, a generic separator for separating a flowable product into different phases or for clarifying a product is known from PCT International patent document WO 2014/000829 A1, which separator has a rotatable drum with a drum lower section and a drum upper section and a clarifying means arranged in the drum, wherein one, several or all of the following elements are made of plastic or a plastic composite material: the drum lower section, the drum upper section, the clarifying means. In this way, it is possible for a section of the drum or preferably even the complete or entire drum—preferably in addition to the intake and outlet systems or regions—to be designed for single use, which is of interest and advantageous particularly with regard to the processing of pharmaceutical products such as fermentation stocks or the like, since following the operation for the processing of a corresponding product batch with preferably continuous operation during the processing of the product batch, no cleaning of the drum has to take place, but instead the drum can be replaced as a whole. This separator is therefore highly advantageous from a purely hygienic point of view.

A further improvement in running properties and also in the handling of the generic structure is therefore desirable—and this is the problem addressed by the invention.

According to an embodiment, the bearing receiving housing is arranged or configured on the housing and a support arrangement is arranged and/or configured between the outer circumference of the bearing device and the inner circumference of the bearing receiving housing, which support arrangement is designed to produce a flexible radial support of the bearing device on the bearing receiving housing and therefore on the housing as a whole. The bearing created in this manner and radial flexible support of the rotating system is compact, constructively and structurally simple and yet very reliable. The drive and, in particular, the drive spindle thereof is/are vibrationally uncoupled from the housing and, in particular, also from the drive motor. A drive motor and the motor housing thereof may be advantageously directly attached to the machine stand in this way, without them necessarily having to be vibrationally uncoupled therefrom.

It is further advantageous in this case for the rotating system to be vertically supported on the bearing receiving housing. This is because a vertically short, particularly compact design is thereby achieved.

It is further advantageous for the housing to be supported on a machine stand and to be wholly or largely vibrationally uncoupled therefrom using at least one support element. This can easily be achieved by providing one or more round bearings as the support element or support elements which are possibly configured or distributed over the circumference between a flange of the housing and an edge of the machine stand.

The drive of the separator may be realized both as a direct drive and also as a drive with a continuous belt drive.

It is preferable that the drum has an outer support device and a drum arranged within the support device—referred to as the inner drum. In addition, a means for clarifying the product to be processed in the centrifugal field is advantageously arranged in the inner drum.

The running performance of the rotating system, in particular the drum, is thereby easily optimized, as the outer support device stabilizes the system. Since the support device lies radially outside relative to the drum wall delimiting the inner space of the drum, the actual drum delimiting the centrifuging chamber is referred to hereafter as the “inner drum”. The compact and yet very reliable drive is particularly well-suited to a structure of this kind.

According to one variant, the outer support device is configured as an outer ring surrounding the inner drum axially in sections. A ring of this kind in the manner of a bandage stabilizes the construction on the outer circumference. The at least one stabilizing ring (or the plurality of rings) is preferably made of metal, but it may also be produced from plastic or a plastic composite material. It is also conceivable for a contour, for example a ring-like pocket open axially in one direction, to be provided on the outer circumference of the inner drum, in which the stabilizing ring is inserted.

It is further advantageous according to a preferred embodiment for the outer support device to be configured as a circumferentially closed outer ring surrounding the inner drum axially in sections. It is also conceivable, however, for the outer support device to be configured as a lattice-type outer ring surrounding the inner drum on a particular axial portion.

According to a different variant, the outer support device is configured as an outer drum surrounding the inner drum wholly or in sections. Particularly in this way, the running behavior of the rotating system, in particular of the drum, is substantially improved, since the outer drum stabilizes the system dynamically and mechanically. Both deflections of the rotating system in a radial direction to the rotational axis D and also the inclination to create an imbalance can be substantially reduced. Both the inner drums, but also the support construction may—but need not—be relatively thin-walled in design. In particular, the inner drum, which should preferably be changed after a product batch has been processed, can thereby be produced in a very material-saving manner.

However, it is still possible for the advantages of the “plastic” material or “plastic composite material” to be used in any event, as it is furthermore possible for part of the drum—all or most constituents of the inner drum and preferably the constituents thereof—in particular all the intake and outlet systems or ranges to be designed for single use, so that following the operation for the processing of a corresponding product batch in the preferably continuous and sanitary operation during the processing of the product batch, no cleaning of the drum must be carried out, but instead the drum as a whole is exchanged. This exchange is therefore particularly simple, as the outer drum, which is preferably reused, does not require a large amount of cleaning, as it preferably has no contact at all with the product being processed. It need not therefore be cleaned and/or disinfected during each changeover of the inner drum, or only for a relatively short time.

The changeover of the inner drum and the assembly, dismantling and other handling thereof can easily be carried out; since there is a stable outer drum construction in this case in which the inner drum need only be inserted, it is possible for the drive connection to an electric motor only to be provided on the outer drum, so that the inner drum is only removed from the outer drum during a changeover and another inner drum has to be inserted therein once again, without this requiring a large number of complicated assembly steps, such as the production of a drive connection to the drive shaft.

In this case, the outer drum may completely surround the inner drum. However, good stabilization of the rotating system also results when the outer drum axially surrounds the inner drum only in sections, preferably over 50% of the axial length of the inner drum or more, in each case.

In the latter case, it is advantageous for the inner drum to project axially from the outer drum, which makes it easy for the intake and outlet region of the inner rum to be clearly separated from and spaced apart from the outer drum.

It is particularly advantageous for the inner drum and the outer drum to be made completely or partially made of different materials, since in this way the optimal materials can be selected in each case for both the outer drum and inner drum elements. The inner drum is preferably made of a likewise preferably relatively thin-walled plastic or a plastic composite material, so that it can easily be disposed of and the reusable outer drum is made of metal, in particular steel, so that its running properties can be particularly effectively optimized.

The advantageous part of this is that when a metallic outer drum and a plastic inner drum are used, the weight of the outer drum may substantially exceed that of the inner drum, so that the rotating behavior is substantially determined by the outer drum. The weight of the rotating parts of the metallic outer drum is preferably more than twice as great, in particular more than four times as great, as the weight of the rotating parts made of plastic or as the weight of the empty inner drum. The outer drum also makes it possible for the inner drum to have a particularly thin-walled configuration, as it is stabilized by the outer drum.

So that the inner drum can be inserted easily and effectively into the outer drum, it is advantageous for the outer drum to have an outer drum lower section and an outer drum upper section that can be detached therefrom. On the other hand, it is advantageous, substantially for production reasons, for the inner drum to have an inner drum lower section and an inner drum upper section that can be preassembled or is preassembled therewith. This is because it is necessary for different elements, such as means for clarifying, an intake pipe and the like, to be positioned in the inner drum during production, which is made easier by the division into an upper section and a lower section.

The assembly of the inner drum in the outer drum is particularly simple when the outer drum upper section is configured in the manner of a ring screwed to the outer drum lower section and which has an open configuration axially upwards, so that the inner drum upper section projects axially from it. The outer drum lower section and the outer drum upper section may also be connected in another way. An advantageous variant is a connection using screw bolts. It is also conceivable for a bayonet nut connector to be used as the connecting means. Finally, it is advantageous for the outer drum upper section and the outer drum lower section to be connected to one another using a locking ring or to be fixed relative to one another. For this purpose, a lower edge of the outer drum upper section is preferably inserted into the outer drum lower section, where it can rest on a collar. Consequently, a ring with an outer thread is screwed from above into an internal thread of the outer drum lower section, which fixes the outer drum upper section on the outer drum lower section.

In order to achieve a secure rotation, wherever possible without slippage between the inner drum and the outer drum, it is advantageous for the inner drum and the outer drum to be connected to one another non-rotatably in a form-fitting or force-fitting manner.

For reasons of hygiene, it is in addition advantageous for an intake system and an outlet system of the drum to be configured exclusively on the inner drum, so that the outer drum does not comes into contact during operation with the product being processed. The intake system and the outlet system are preferably configured in a sealed design on the inner drum.

In a further embodiment, it is advantageous for the intake system and the outlet system to have a covering ring body configured as a part that does not rotate with the drum during operation and for the intake system to have an intake pipe which is configured as an element rotating with the drum. In this way, the transition of the product into the rotating system is already achieved at the inlet of the intake pipe, which simplifies the design of the inner drum. However, it is also conceivable for the drainage system to be realized with the help of one or a plurality of grippers made of plastic which, in the manner of centripetal pumps, conduct one or more phases divided in the centrifugal field from the drum.

Overall, the design of the inner drum is also associated with some, and preferably even all, of the product-contacting regions of the rotating system made of a plastic or a plastic composite material, in particular the inner drum lower section and the inner drum upper section and the plate pack. Particularly preferably, the intake system and the outlet system are furthermore made of a plastic or a plastic composite material.

It is particularly advantageous for all parts of the inner drum, which rotate during operation, and parts of its intake and outlet system, which do not rotate during operation,—insofar as they come into contact with the product—to be made of plastic and for all parts, even those which only number a few, e.g., injection-molded plastic parts, to be provided—except for any seals which may have to be provided. These are preferably the inner drum lower section, the inner drum upper section, the distributor, the separating means (preferably the plate insert for separating solids), a separating plate and the discharger. In addition, there may still be sealing rings. In this way, a functional centrifugal drum is created from plastic, which drum comprises only a very small number of constituents, making its production and assembly particularly simple. The separating plate and the inner drum upper section elements could also be configured in one piece. In this case, the drum upper section would be provided directly with one or a plurality of channels, through which one or several phases can flow out of a region with a larger diameter in the drum to the tip thereof up to a discharge out of the rotating system, as on a separating plate or similar.

In addition, it is particularly advantageous in this case for the inner drum lower section and the inner drum upper section to be connected to one another in a non-detachable manner during the initial assembly, in order to prevent attempts being made to dismantle them and possibly reuse them following inadequate cleaning. Instead of this, the inner drum is completely disposed of or recycled. It is also advantageous in this case for the sterility to be guaranteed. The design is preferably such that before installation and following dismantling no air can penetrate the inner drum from outside.

The design of the inner drum makes it furthermore possible, as in the case of PCT International patent document WO 2014/000829 A1, for part of the drum, or preferably even the entire drum—preferably in addition to the intake and outlet systems or regions—to be designed for single use, which is of interest and advantageous particularly with regard to the processing of pharmaceutical products such as fermentation broths or the like, because following the operation for the processing of a corresponding product batch with preferably continuous operation during the processing of the product batch, no cleaning of the drum has to take place, but instead the drum can be replaced as a whole. Hygiene problems associated with cleaning are thereby easily precluded. The product-contacting parts can be completely disposed of or recycled. Disposal is also of particular interest with hazardous substances. In turn, it is also conceivable, with a clarifying action of a product, for the product requiring processing to be concentrated to begin with and for the inner drum to be melted down following the processing of a batch or, for example, dissolved in an acid or the like, in order to extract the heavy material left as a residue of this process. Through the use of preferably thin-walled plastic parts, the production costs can, in particular, be kept relatively low.

In turn, it is advantageous in this case and particularly hygienic for the entire drum, in particular including its intake system and outlet system, to be configured in a sealed design.

A recyclable plastic is preferably used as the plastic, in particular PE (polyethylene), PP (polypropylene), or TK-PEEK (in particular partially crystalline) polyether ether ketone. Other possible materials (and this is not a definitive list) include PC (polycarbonate), MABS (methylmethacrylate acrylonitrile butadiene styrene), ABS (acrylonitrile butadiene styrene) and PSU (polysulfone).

The parts produced from plastic could be manufactured using the injection molding method and reworked where necessary, e.g., provided with bores and the like where this is necessary.

Screws and the like may also be made of plastic, but they may, in particular when they do not come into contact with the product during processing, also be produced from a different material.

In an embodiment, a non-rotatable abutment is provided outside the drum, wherein between the abutment and the drum above the largest radial diameter of the drum is arranged at least one (further) bearing device for mounting the drum, which bearing device has at least one bearing. This advantageous—but not compulsory—bearing option further supplements the bearing device provided for vertically below the largest diameter of the drum and contributes to an advantageous rotational behavior of the drum.

In this case, it is structurally simple and advantageous for the abutment to be a covering ring body configured as the part not rotating with the drum during operation. If sealing arrangements are disposed between the covering ring body, which does not rotate during operation, and the inner drum, the bearing above the drum advantageously helps excessive heating of the sealing arrangements to be prevented.

### BRIEF DESCRIPTION OF THE DRAWING FIGURES

The invention is described in greater detail below with the help of exemplary embodiments with reference to the figures. In the figures:

FIG. 1 shows in a) a view of a first exemplary embodiment of a separator according to the invention with a drive having a continuous belt drive with the housing depicted in cross section and the drum depicted in cross section and in b) a detail enlargement of a bearing region from a);

FIG. 2 shows a view of a second exemplary embodiment of a separator according to the invention with a direct drive;

FIGS. 3a and 3b show a view of an upper housing section according to the invention.

### DETAILED DESCRIPTION

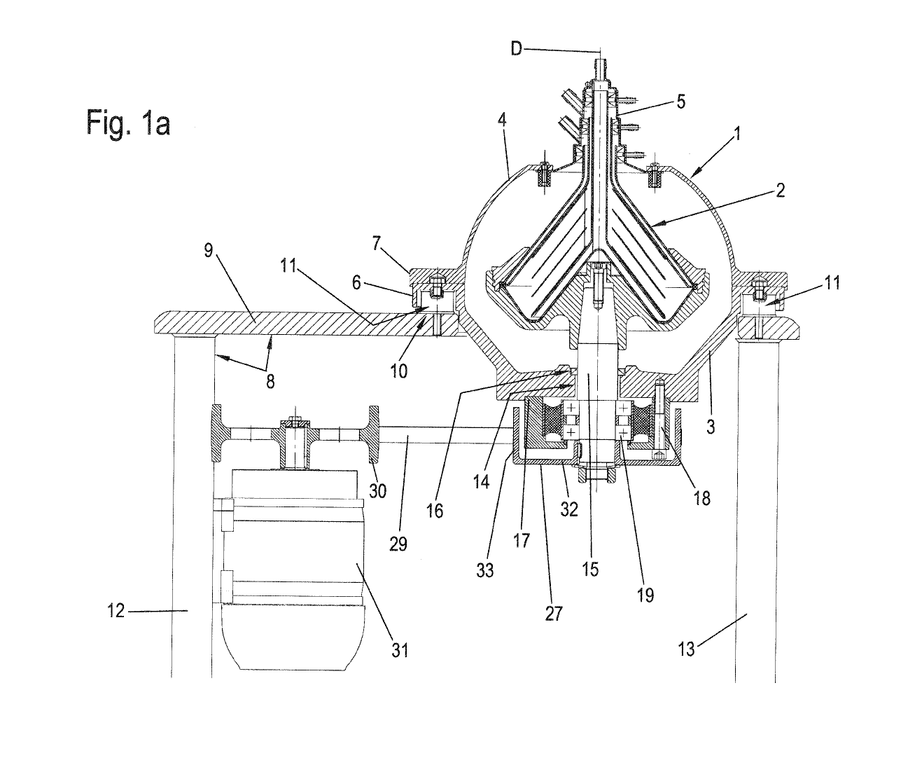

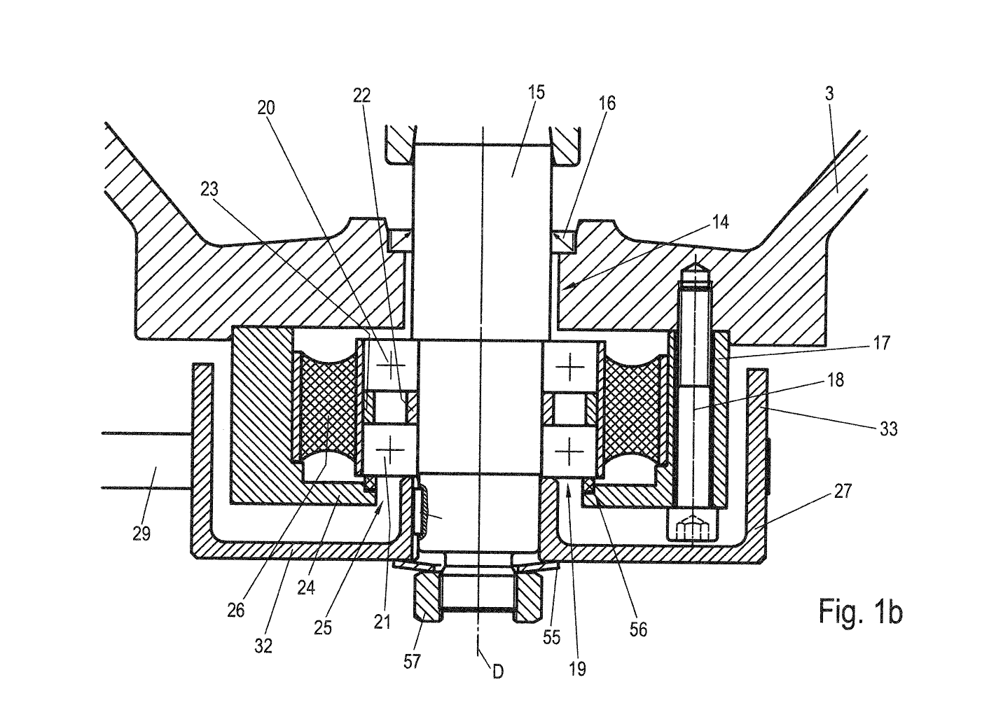

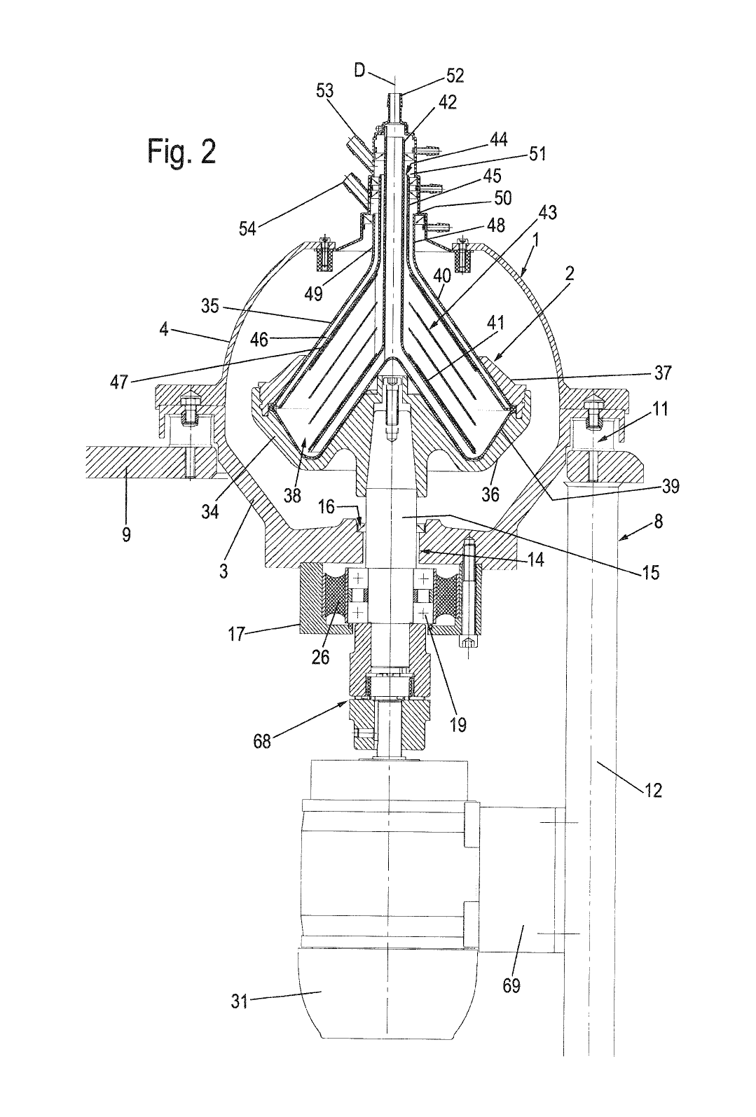

The following embodiments, up to reference number 27, relate both to the exemplary embodiment in FIG. 1 and also to that in FIG. 2.

FIGS. 1 and 2 show a section through the region of a housing 1 and a drum 2 of a separator according to the invention, by means of which a liquid product can be separated into two phases in the centrifugal field. The drum 2 has a vertical rotational axis D. Terms used below such as “top” or “bottom” relate to the orientation of elements of the separator in relation to this vertical rotational axis.

The housing 1 has a housing lower section 3 and a housing upper section 4. In addition, a covering ring body 5 is secured to a central opening in the housing upper section. The covering ring body 5 covers a or the rotating system of the separator with the drum 2 upwardly and an intake and an outlet function are realized thereon. The function of the outlet ring body 5 is addressed in greater detail below.

An upper edge region of the housing lower section 3 forms a flange portion 6 for a lower flange portion 7 of the housing upper section 4. The housing lower section 3 and the housing upper section 4 are preferably screwed to one another in this flange region.

Additionally, the housing 1 is supported on a machine stand 8. In this case, the machine stand 8 has at least one plate or a frame 9 on which the housing 1 rests. Support elements 11 are preferably arranged distributed around the circumference between the lower side of the flange portion 6 of the housing 1 and an upper edge 10 of the frame 9 or of the table. The support elements 11 produce the best possible vibrational decoupling of the housing 1 from the frame 9 and the rest of the machine stand 8. It is advantageous and very appropriate in constructional terms for these support elements 11 to be configured as round bearings. The number of support elements 11 distributed around the circumference may be determined numerically or by testing. At least three or more support elements 11 distributed around the circumference 11 may advantageously be provided.

It should be noted in this connection that the machine stand 8 is only depicted sectionally. It is inherently achievable in various ways and may, for example, also be configured in the manner of a table or a closable cupboard. It is preferably fastened to a base (not shown in this case). FIG. 1a shows vertical struts 12, 13 of the machine stand. FIG. 2 only shows one of the vertical struts 12, 13 supporting the frame 9 or plate.

The housing lower section 3 has a bushing 14, which has a rotatable drive spindle 15 for the drum 2 passing through it. The drum 2 is mounted on an upper end of the drive spindle 15 and connected thereto in a non-rotational manner. In this case, a seal 16 is arranged between the outer circumference of the drive spindle 15 and the inner circumference of the bushing 14.

A bearing receiving housing 17 is preferably configured below the housing 1, in particular the housing lower section 3. This bearing receiving housing 17 may, for example, be fixed using one or a plurality of screw bolts 18 to the housing 1, in particular to the housing lower section 3.

A bearing device 19 for mounting the drive spindle 15 is arranged within the bearing receiving housing 17 (see also FIG. 1b). This bearing device 19 has at least a single bearing or two or more bearings. In this case, the bearing device 19 has two bearings 20, 21 lying vertically one above the other. These bearings are preferably each configured as roller bearings. One or more spacer sleeves 22, 23 are arranged between the bearings 20, 21 in this case, in order to axially space the bearings 20, 21 in a simply defined manner.

The lower bearing 21—see also FIG. 2—is supported vertically outwardly on the bearing receiving housing 17, in particular on a radial wall 24 of the bearing receiving housing 17, preferably via an elastomer ring 56. In this way, the rotating system is vertically supported on the bearing receiving housing 17. This site of the vertical support is therefore just below the drum 2. A second bearing device, in addition to the two bearings 20, 21 of the first step-bearing-like bearing device, can be dispensed with.

The radial wall 24 (FIG. 1b) of the bearing receiving housing 17 has, in addition, a central bushing 25 which passes through the drive spindle 15 downwardly.

A support arrangement 26 is arranged between the outer circumference of the bearing device 19 and the inner circumference of the bearing receiving housing 17. This support arrangement 26 is configured so that a flexible support of the bearing device on the bearing receiving housing 17, and therefore on the housing 1 as a whole, can be achieved.

It is advantageous for this support arrangement 26 to be formed from a (preferably single) ultra-bushing. On the inner diameter of the ultra-bushing, this is placed on the outer circumference of the bearing device 19. On the outer circumference, this ultra-bushing is arranged in the inner circumference of the bearing receiving housing 17. The bearing receiving housing 17 may also form an integral portion of the housing lower section 3 (now shown here). It is structurally simpler, however, for it to be fastened to the housing lower section 3. The ultra-bushing preferably has a variable stiffness. Right around the drive spindle, it may possibly exhibit portions of different cross section for this purpose, preferably produced by hollow chambers, grooves or the like.

In this way, the weight of the drum 2 is supported vertically on the housing 1 and a radial vibrational decoupling of the rotating system from the housing 1 is achieved by simple means.

The drive spindle 15 projects vertically downwards from the housing 1 with the bearing receiving housing 17. The transmission of a driving torque to the drive spindle 15 takes place in this region.

According to FIGS. 1a and b, a belt pulley 27 is connected for this purpose in a non-rotational manner to the drive spindle 15, for example with the help of one or more torque transfer elements 28 between the drive spindle 15 and the belt pulley 27.

The belt pulley 27 is surrounded by a continuous belt drive, in particular a drive belt 29 (also see again FIG. 1a), which further encloses a drive plate 30 on a drive motor 31. The drive motor 31 is fastened to the machine stand 8, in this case to one of the vertical struts 12 of the machine stand 8.

The belt pulley 27 is preferably configured in such a manner that it has at least one radial wall 32 and an axial casing 33, wherein the axial casing 33 extends vertically upwards from the radial wall 32. This extension is preferably such that the axial casing 33 or else the axial sleeve portion in any case lies sectionally at a vertical height (in a perpendicular direction to the rotational axis D) of the bearing device 19 or at least of the bearing receiving housing 17, from which it is radially spaced apart. In this way, it is possible for the drive belt 29 to vertically enclose the axial casing 33 on the outside completely or sectionally at the height of the bearing device 19, which is advantageous during operation.

A spring, in particular a plate spring 55, may be secured to the lowermost portion of the drive spindle which may project vertically downwards out of the belt pulley 27, which spring is supported on the drive spindle 15 or a ring secured on the drive spindle 15—in this case a nut 57—and, on the other hand, on the drive pulley 27, so that in this way the belt pulley 27 can easily be pretensioned vertically in the direction of the bearing device.

Alternatively, instead of a continuous belt drive for driving the drive spindle 15 or the drum, a direct drive may also be achieved (see FIG. 2).

The design of the drive with the direct drive largely corresponds to that in FIG. 1. The essential difference is that the drive motor 31 is provided directly in a vertical extension of the drive spindles 15. A coupling 68 may be provided between the drive spindle 15 and the drive motor 31. The drive motor may, in turn, preferably be fixed to the machine stand 8, for example using one or more struts 69.

This construction is simple and robust and very well suited to the lightweight drum construction.

The drum 2 is in turn mounted on the vertically upper end of the drive spindle 15 in a non-rotatable manner relative to the drive spindle 15, so that it can be set in rotation by the drive spindle 15.

The two drives presented with reference to FIG. 1 and FIG. 2 are inherently suitable for rotatable separator drums of various kinds. It is particularly suitable for the drum presented below which is explained with reference to FIG. 2, but is constructed in FIG. 2 as in FIG. 1.

The drum 2 has an outer drum 34, which may also be configured as an outer drum section, and an inner drum 35. The inner drum 35 is inserted in an exchangeable manner in the outer drum 34.

The outer drum portion or else the outer drum 34 and the inner drum 35 are preferably made of different materials. The outer drum 34 is particularly preferably made of metal, in particular steel, and the inner drum 35 is preferably made completely or at least partially from a plastic or a plastic composite material.

The outer drum 34 in this case is used as a kind of holder into which the inner drum 35 is inserted and which surrounds or encloses the inner drum 35 in its entirety in a vertical or axial direction at least in sections. The outer drum 34 and the inner drum 35 are particularly preferably connected to one another in a non-rotatable manner. This may, in particular, be achieved through a form-fitting and/or force-fitting connection between the outer drum 34 and the inner drum 35.

The outer drum 34 has an outer drum lower section 36 which may be, or in this case is, configured substantially like the drum lower section of known separators without an inner drum. The outer drum lower section 36 is mounted on the drive spindle 15 in a non-rotatable manner and preferably has on the inside a simple or, in this case, particularly preferred double-conical inner form. The outer drum 34 preferably has, in addition, an outer drum upper section 37. The outer drum lower section 36 and the outer drum upper section 37 preferably exhibit corresponding threads, in the region whereof they are directly screwed to one another. However, a locking ring may also be provided.

For a drum of this kind with an inner drum and an outer drum 35, 34, the structurally simple and vertically compact drive presented in FIGS. 1 and 2 has proved very quiet-running.

The outer drum upper section 37 likewise has a conical design. In addition, it is configured as a ring connected to the outer drum lower section 36 at the bottom in a non-rotatable manner and which is configured to be upwardly open, so that the inner drum 35 projects vertically or axially upwards out of the outer drum, in this case out of the outer drum upper section 37.

Because the outer drum lower section 36 and the outer drum upper section 37 are preferably made of metal, in particular steel, and at least the drum lower section is preferably configured like the one separator drum without an inner drum 35, they can largely offer the quietness and stability and reliability of a known modern separator drum made of metal. Because the outer drum 34 surrounds the inner drum 35 externally in sections or entirely, the outer drum stabilizes the inner drum 35. In particular, the outer drum 34 advantageously helps to optimize the running properties of the entire drum 2 when operating at a high speed. In addition, the chosen wall thickness of the inner drum 35 may also be very much thinner than the one separator drum without an outer drum 34 made solely from plastic, as proposed in PCT International patent document WO 2014/00829 A1.

The inner drum 35, on the other hand, outwardly delimits the actual separating or centrifuging chamber 38 for the centrifugal processing of a flowable product.

The inner drum 35 is configured in relation to its shaping in such a manner that it preferably directly abuts the inner circumference of the outer drum in a largely form-fitting manner.

The inner drum 35 preferably has an inner drum lower section 39 and an inner drum upper section 40. The inner drum lower section 39 and the inner drum upper section 40 are each preferably conical in design, so that a double-conical body is formed. The parts 39 and 40 are made of plastic or a plastic composite material and are connected to one another in a liquid-tight manner, particularly in upper flange regions.

A substance-bonded connection between the inner drum lower section 39 and the inner drum upper section 40 and possibly further elements of the inner drum 35 are preferably provided, which can be achieved within the meaning of this document, for example by fusion, but also by adhesion.

Other kinds of connection are also conceivable, however, such as a bayonet catch between the elements to be connected—the inner drum lower section 39 and the inner drum upper section 40 (not shown).

Other connection variants are also advantageously achievable between the inner drum lower section 39 and the inner drum upper section 40, such as screw connections with plastic screws and nuts or the like (not shown here). It is also an appropriate connection for the inner drum lower section and the inner drum upper section to be clamped together at their outer circumference using one or multiple clamps (not shown here). These kinds of connections between the inner drum parts 39, 40 are easy to handle, can be produced cost-effectively and yet are very functionally reliable.

A distributor 41 is configured in the inner drum 35. An intake pipe 42 projects into the inner drum. Separating means or means for clarifying such as, in particular, a one-part or preferably a multi-part plate pack 43 are arranged in the centrifuging chamber 38 and are configured as a stack of axially spaced separating plates having a conical basic shape and which are preferably fitted to the distributor 41 in a non-rotatable manner. The separating means for clarifying could also be configured in another shape, such as a ribbed body with radial or arcuate ribs. The separating plates have the same or different radii.

During operation when the drum 2 rotates, a lighter liquid phase flows radially upwards into an annular channel 44 which is configured between the outer circumference of the intake pipe 42 and a pipe section 45 with a greater diameter which likewise projects from above into the inner drum upper section 40.

A conical plate is attached, in particular adhered or molded, to the bottom of this pipe section 45, which plate is arranged in the manner of an upper separating plate 46 above the plate pack 43, wherein it is spaced apart from the inner drum upper section 40, so that a gap 47 is formed between the inner drum upper 40 and the separating plate.

A heavier liquid phase (or a still dischargeable, in particular a still slightly flowable, liquid phase) is conducted from the region of the greatest inner circumference of the drum inner chamber through one or a plurality of bores in the radially outer region of the separating plate into the gap 47 acting as a channel between the inner drum upper section 40 and the separating plate 46, namely preferably into a second annular channel 48—or into one or a plurality of channels which are preferably spaced apart by ribs—between the pipe section surrounding the intake pipe and an axial pipe attachment 49 of the inner drum upper section 40.

The heavier and lighter liquid phases flow upwards in each case in annular chambers 50, 51 arranged axially above one another in the covering annular body 5, which is fastened to the housing 1 in a non-rotatable manner. It is advantageous for nozzles or the like leading radially from the drum 2 in this way for fluid discharge to be dispensed with, so that there is no contact between the inside of the drum 2 and the surroundings in the container. Alternatively, however, the discharge could also take place with skimmer discs (not shown in this case).

The covering ring body 5 preferably has a stepped design and preferably has connecting pieces 52, 53, 54 for the incoming and outgoing phase. Tubes can be attached to these, for example adhesively.

In order to connect the inner drum 35 and the outer drum 34 to one another simply in a non-rotatable but detachable manner when at a standstill, the inner drum 35 can be connected to the outer drum 34 in a form-fitting and/or force-fitting manner. Hence, form-fitting means such as ribs, for example, may be provided on the outer surface of the inner drum and corresponding grooves on the inner circumference of the outer drum 34, which engage with one another and connect the two elements—the inner drum 35 and the outer drum 34—to one another in a non-rotatable manner (not shown here).

During operation, the inner drum 35 is, in addition, placed in a radially expanding manner on the inner circumference of the outer drum 34, which improves the torque transmission and rotating entrainment of the inner drum 35 through the driven outer drum 34. Alternatively, it would also be conceivable for sections of the outer drum to be connected to one another detachably by other means, such as using screw bolts or the like or by means of a bayonet catch.

In this way, part or preferably even all, of the product-contacting regions of the rotating system are made of plastic or a plastic composite material, in particular the inner drum lower section 39 and the inner drum upper section 40. Particularly preferably, the separating plates, in addition, are made of plastic and also all the product-contacting regions of the intake system and the outlet system, also insofar as these do not rotate during operation. If necessary, a small number of parts of the inner drum may also be made of another material.

In this way, the inner drum 35 can be disposed of once a sufficiently large product batch has been processed. The preferably metallic outer drum 34, on the other hand, is reused because it cannot come into contact with the product during operation, and thus its cleaning is very simple or else less important. Through the outer drum 34, the inner drum 35 may have quite a thin-walled design. In case of complete disposal, a very small amount of waste plastic is accordingly produced.

The figures show an embodiment as a two-phase separating machine (separation of a product into the “liquid/liquid” phases), three-phase machines (for separating into three phases) are likewise achievable (not shown here). The product is preferably, but not necessarily, a fermentation stock requiring concentration.

The entire or whole inner drum 35 or, in any event, most of the elements of the inner drum 35, in addition to the intake and outlet system, are preferably designed as a replaceable, preassembled module made of plastic or a plastic composite material. Only a small number of individual elements, such as sleeves on seals or the like, can be made of metal, in order to receive and/or discharge thermal energy—particularly when starting the drum.

The outer drum 34 in this case is substantially used as a holder for the inner drum 35 which particularly improves the running properties of the inner drum 35.

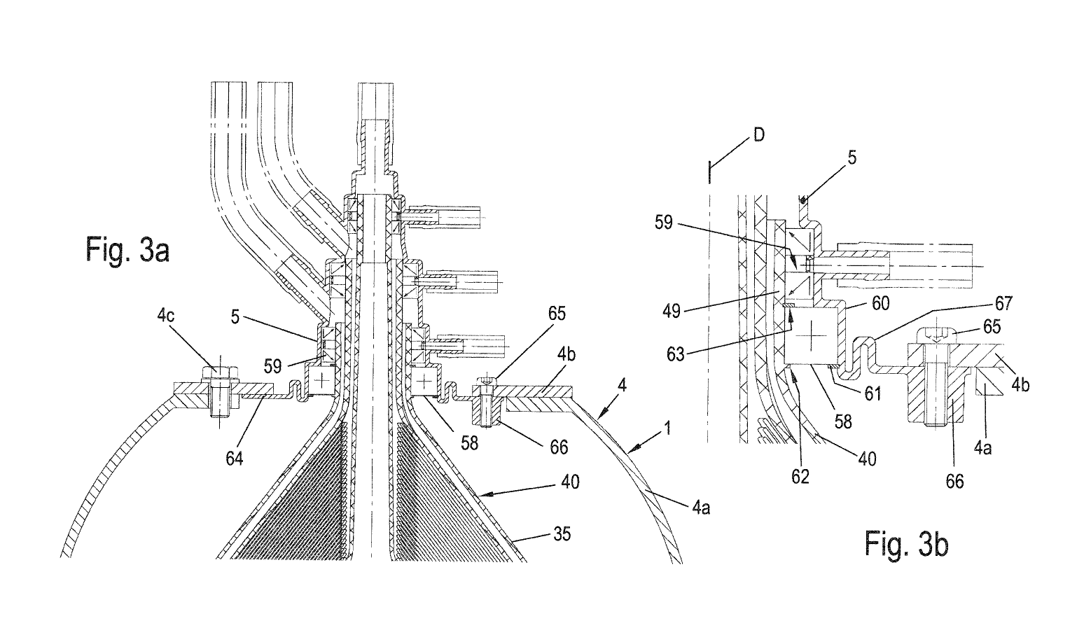

As illustrated in FIGS. 3a and 3b, between the covering ring body 5 and the plastic drum, in particular the inner drum 35, a (further) bearing device is preferably configured, particularly with a single bearing 58. This bearing device is particularly advantageous in further optimizing the running properties of the rotating system, particularly when interacting with the bearing device 19 vertically below the drum. A single bearing 58 has proved sufficient in itself. However, it is also conceivable for two or more bearings to be provided instead of the one bearing 58. The bearing 58 is preferably a roller body bearing, in particular a ball bearing. A roller body bearing ensures particularly quiet running and sets the radial distance between the covering ring body 5 and the drum 2 in a defined manner. It is possible, however, for a different bearing to be provided in this region, such as an air bearing or a magnet bearing or, in some cases, a friction bearing. The bearing 58 may be made of plastic or of a plastic composite material. However, it is also conceivable for it to be produced from metal and/or plastic and/or from a plurality of different materials.

The bearing 58 is preferably retained below a seal arrangement 59 between the covering ring body 5 and the inner drum 35 in the covering ring body 5. The inner part of the bearing 58 is externally connected in a non-rotatable manner to the inner drum upper section 40, in particular to the tubular attachment 49 thereof.

The covering ring body 5 preferably has a correspondingly shaped bearing receiving means 60 for receiving the bearing 58. This allows the arrangement and receiving of the bearing 58 in a simple manner. The bearing receiving means 60 is preferably configured as an axially downwardly open graduation in the covering ring body 5. It preferably lies below the lower seal arrangement 59.

The bearing 58 is retained downwardly in the covering ring body 5 by a web or a completely or partially surrounding ring 61 made of plastic which projects inwards radially from the covering ring body and is secured thereto following the insertion of the bearing, e.g., in an adhesive or locking manner to a groove of the covering ring body 5.

On the tubular attachment 49 of the inner drum 35, the bearing 58 is preferably retained downwardly by a radially outwardly projecting collar 62 and upwardly preferably by a radially outwardly projecting web or ring 63 which is inserted in this case into a groove in the attachment and can be fastened there in addition in an adhesive manner.

The covering ring body or the covering ring housing 5 expands further radially outwards to the bearing receiving means 60. It ends radially outwardly in a flange portion 64 acting as a fastening region that is fastened in this case to the housing 1, which does not rotate during operation. This happens here with screws 65 passing through bores in the housing upper section 4 of the housing 1 in a circumferentially distributed manner and which are screwed into the screw receiving means 66 which are formed on the covering ring body 5. This kind of fastening is preferred. However, other kinds of fastening of the covering ring body 5 to the housing 1 can be achieved. The housing upper section 4 may be configured in one piece (FIG. 2). According to FIG. 3a, it comprises two portions 4a and 4b connected to one another, e.g., by screws 4c, wherein the portion 4b has screws 65 passing through it. The portion 4a may be mounted on the covering ring body 5 in this manner beforehand and then fastened to the portion 4b. Both portions 4a and 4b or the one-piece housing upper section 4 is/are mounted vertically from above on the covering ring body 5.

A deflection balancing region 67 is preferably configured on the covering ring body 5 radially between the bearing receiving means 60 and the fastening region of the covering ring body 5 for fastening to the housing 1, in particular to the housing upper part 4. This may comprise one or a plurality of folds. The folds preferably run radially, so that a concertina-like geometry and function results. Deflections of the rotational axis D of the rotating system with the drum are easily received or balanced in this way. In this case, the additional bearing 58 between the covering ring body 5 and the drum, in particular the inner drum upper section 40, leads to particularly good running properties of the rotating system.

As can further be seen in FIGS. 3a and 3b, the bearing 58 is preferably and advantageously used to set a defined relative position, in particular a defined fixed radial spacing, between the covering ring body 5, which does not rotate during operation, and the drum 2, in particular the inner drum 35. This makes it easier to precisely position the one or multiple seal arrangement(s) 59 on the inside of the covering ring body. The sealing arrangement(s) 59 is/are furthermore well protected from damage, as particularly the radial, but also the axial, distance between the covering ring body 5 and the rotating system with the drum 2 cannot change during operation. To this extent, it is also advantageous for the bearing 58 to be axially as close as possible to one of the, in particular the lowest, of the seal arrangements 59.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### REFERENCE NUMBERS

Housing 1
Drum 2
Housing upper section 3
Housing lower section 4
Portions 4a, b
Covering ring body 5
Flange portions 6, 7
Machine stand 8
Frame 9
Edge 10
Support elements 11
Struts 12, 13
Bushing 14
Drive spindle 15
Seal 16
Bearing receiving housing 17
Screw bolt 18
Bearing device 19
Bearing 20, 21
Spacer sleeves 22, 23
Radial wall 24
Bushing 25
Support arrangement 26
Belt pulley 27
Torque transmission elements 28
Drive belt 29
Drive plate 30
Drive motor 31
Radial wall 32
Axial casing 33
Outer drum 34
Inner drum 35
Outer drum lower section 36
Outer drum upper section 37
Centrifuging chamber 38
Inner drum lower section 39
Inner drum upper section 40
Distributor 41
Intake pipe 42
Plate pack 43
Annular channel 44
Pipe section 45
Separating plate 46
Gap 47
Annular channel 48
Pipe attachment 49
Annular chambers 50, 51
Connection attachments 52, 53, 54
Plate spring 55
Elastomer ring 56
Nut 57
Bearing 58
Seal arrangement 59
Bearing receiving means 60
Ring 61
Collar 62
Ring 63
Flange portion 64
Screws 65
Screw receiving means 66
Deflection balancing region 67
Coupling 68
Struts 69
Vertical rotational axis D

1-34. (canceled)

35. A separator for the centrifugal processing of a flowable product, the separator comprising:
a rotating system with
i. at least one rotatable drum delimiting a centrifugal chamber; and
ii. at least one drive spindle configured to rotate or drive the drum,
a non-rotatable housing at least surrounding the drum;
a bearing device configured for mounting the drive spindle in a bearing receiving housing, wherein the bearing device is arranged or configured on the non-rotatable housing,
a support arrangement between an outer circumference of the bearing device and an inner circumference of the bearing receiving housing, wherein the support arrangement is configured to provide a flexible support of the bearing device on the bearing receiving housing and on the non-rotatable housing as a whole.

36. The separator of claim 35, wherein the rotating system is vertically supported on the bearing receiving housing.

37. The separator of claim 35, wherein the non-rotatable housing has at least one housing lower section and a housing upper section to which a covering ring body is secured.

38. The separator of claim 35, wherein the non-rotatable housing is supported on a machine stand and is wholly or largely vibrationally uncoupled therefrom using at least one support element.

39. The separator of claim 38, wherein one or more round bearings are provided as the support element or support elements, which are configured or distributed over the circumference between a flange of the non-rotatable housing and an edge of the machine stand.

40. The separator of claim 35, wherein the drum is mounted on an upper end of the drive spindle and connected thereto in a non-rotational manner.

41. The separator of claim 35, wherein a seal is arranged between the outer circumference of the drive spindle and the inner circumference of a bushing in the non-rotatable housing.

42. The separator of claim 35, wherein the bearing receiving housing is fixed using one or a plurality of screw bolts to the housing lower section.

43. The separator of claim 35, wherein the bearing device for mounting the drive spindle is arranged within the bearing receiving housing and the bearing device has a single bearing or two or more bearings.

44. The separator of claim 43, wherein one or more spacer sleeves are arranged between the bearings.

45. The separator of claim 43, wherein a bearing or a lowest of the bearings is supported vertically downwardly on a radial wall of the bearing receiving housing via an elastomer ring.

46. The separator of claim 45, wherein the radial wall of the bearing receiving housing has a central bushing passing through the drive spindle downwardly.

47. The separator of claim 35, wherein the support arrangement is formed from a single ultra-bushing which surrounds the bearing device radially on the outside.

48. The separator of claim 35, wherein the drive spindle projects vertically downwards from the non-rotatable housing and/or with the bearing receiving housing and transmission of a driving torque to the drive spindle occurs in this region.

49. The separator of claim 35, wherein the drive spindle is driven by a belt pulley and a continuous belt drive is connected to the drive spindle in a non-rotatable manner.

50. The separator of claim 49, wherein a drive belt of the continuous belt drive lies vertically at a height of the bearing device in the drive housing.

51. The separator of claim 35, wherein the drive spindle is driven by a direct drive.

52. The separator of claim 35, wherein a drive motor is fastened to the machine stand.

53. The separator of claim 49, wherein the belt pulley is configured in such a manner that it has at least one radial wall and an axial casing, wherein the axial casing extends vertically upwards from the radial wall, and wherein the extension of the axial casing is such that the axial casing lies sectionally at a vertical height of the bearing device or at least of the bearing receiving housing, from which it is radially spaced apart.

54. The separator of claim 35, wherein the drum has an outer support device and an inner drum arranged in the outer support device.

55. The separator of claim 54, wherein a means for clarifying the product to be processed in the centrifugal field is arranged in the inner drum.

56. The separator of claim 54, wherein the outer support device is configured as an outer drum in which the inner drum is arranged.

57. The separator of claim 56, wherein the outer drum surrounds the inner drum axially only in sections.

58. The separator of claim 56, wherein the inner drum and the outer drum are made of different materials.

59. The separator of claim 54, wherein the inner drum is made completely or for the most part of plastic or a plastic composite material.

60. The separator of claim 56, wherein the outer drum is made of a metal.

61. The separator of claim 56, wherein the outer drum has an outer drum lower section and an outer drum upper section.

62. The separator of claim 61, wherein the outer drum upper section is configured as a ring and is configured to be upwardly open axially, so that the inner drum upper section projects axially from it.

63. The separator of claim 56, wherein the inner drum and the outer drum are connected to one another non-rotatably in a form-fitting and/or force-fitting manner.

64. The separator of claim 56, wherein the outer drum is driven by the drive spindle.

65. The separator of claim 54, wherein an intake system and an outlet system of the drum are configured exclusively on the inner drum.

66. The separator of claim 56, wherein the following parts are configured in single or double conical form: an upper section of the outer and inner drums and a lower section of the outer and inner drums.

67. The separator of claim 35, wherein a non-rotatable abutment is provided outside the drum, wherein between the abutment and the drum above the largest radial diameter of the drum is arranged at least one bearing device for mounting the drum, which bearing device has at least one bearing.

68. The separator of claim 67, wherein the abutment is a covering ring body or the non-rotatable housing.
